(19) United States
(12) Patent Application Publication
(10) Pub. No.: US 2008/0198134 A1
(43) Pub. Date: Aug. 21, 2008

(54) Wireless device and power-saving device thereof

(75) Inventors: Chiung-Chih Huang, Taipei (TW); Chien-Hsin Lee, Banciao (TW)

Correspondence Address: BACON & THOMAS, PLLC, 625 SLATERS LANE, FOURTH FLOOR, ALEXANDRIA, VA, 22314, US

(73) Assignee: LITE-ON TECHNOLOGY CORPORATION, Taipei (TW)

(21) Appl. No.: 11/889,500

(22) Filed: Aug. 14, 2007

(30) Foreign Application Priority Data
Feb. 15, 2007 (TW) 96105821

(51) Int. Cl. G06F 3/033

(52) U.S. Cl. 345/166

(57) ABSTRACT

A wireless device and a power-saving device thereof are provided. The power-saving device includes a bracket, a rocker arm and a struck element. The bracket is electrically connected to a circuit board of the wireless device. The rocker arm is movably disposed on the bracket. The struck element is disposed around the rocker arm and electrically connected to the circuit board. When the wireless device is moved and makes the rocker arm move waveringly and touch the struck element, the circuit board is therefore conducted, such that the wireless device switches from a sleep mode to an operation mode.

This application claims the benefit of Taiwan application Serial No. 96105821, filed Feb. 15, 2007, the subject matter of which is incorporated herein by reference.

### BACKGROUND OF THE INVENTION

1. Field of the Invention

The invention relates in general to a wireless device and a power-saving device thereof, and more particularly to a wireless device capable of reducing power consumption and a power-saving device thereof.

2. Description of the Related Art

The connections between computers, workstations, home appliances and their peripheral devices can be achieved in different ways, for example, cable connection or wireless connection. However, cable connection limits the movement scopes of the peripheral devices; furthermore, the cable arrangement is complicated. Currently, many computer peripheral devices, such as a mouse or a keyboard, are wirelessly connected to computers for convenience. Normally, a wireless mouse communicates with a computer by way of radio frequency transmission or infrared transmission.

The wireless mouse is usually energized by a battery with limited lifespan. As the wireless mouse is not always in use, a sleep mode is used to lower the power consumption of the wireless mouse and prolong the battery lifespan. The in-built modes of the wireless mouse include an operation mode, an idle mode, a sleep mode and a deep sleep mode. The levers of the power consumption for the four modes are ranked from high to low in the order of the operation mode, the idle mode, the sleep mode and the deep sleep mode.

When the wireless mouse is in the operation mode, the controlling unit of the wireless mouse detects the movement of the wireless mouse and the status of the press keys so as to control the wireless communication module. Normally, the power consumption of the wireless mouse in the operation mode is approximate to 14 milli-ampere (mA). Despite the wireless mouse turns off the wireless communication module when the wireless is in the idle mode, the controlling unit is still able to detect the movement of the wireless mouse and resume the operation mode. The power consumption of the wireless mouse in the idle mode is approximate to 5˜7 mA. The power consumption of the wireless mouse in the sleep mode or the deep sleep mode is approximate to 60˜110 micro-ampere (μA). When the wireless mouse is in the deep sleep mode, the controlling unit of the wireless mouse not only turns off the wireless communication module but also stops detecting the movement of the wireless mouse.

Conventionally, when the wireless mouse is in the idle mode or the sleep mode, the controlling unit detects whether the press key is pressed or not. Only when the press key is pressed, the wireless mouse will switch to the operation mode from the idle mode or the sleep mode. Merely holding or moving the wireless mouse does not make the wireless mouse resume the operation mode. If the wireless mouse is not used over a long period of time, the controlling unit is subjected to a loop whose unit of measurement is 1 second. The idle mode of the mouse is activated after the mouse has been idled for 320 seconds; meanwhile, the movement of the mouse still needs to be detected to resume the operation mode. However, if the mouse has been idled over 680 seconds, the deep sleep mode will be activated to save power. The shortcoming for the above method is that a user's operation is omitted when the wireless mouse is in the deep sleep mode, resulting in a slower response to the user's operation. Furthermore, when the user stop using the wireless mouse, the idle mode of the wireless mouse will be activated again, it consumes more power than sleep mode or deep sleep mode, and the energy of the battery would run out more quickly.

Therefore, how to lower the power consumption of the wireless mouse and enable the wireless mouse to resume the operation mode in quick response to the user's operation after the wireless mouse has been idled for long duration has become critical in the design of wireless mouse.

### SUMMARY OF THE INVENTION

The invention is directed to a wireless device and a power-saving device thereof. When the wireless mouse is in a sleep mode, the power-saving device detects the movement of the wireless device without consuming battery power.

According to a first aspect of the present invention, a power-saving device used in a wireless device is provided. The power-saving device includes a bracket, a rocker arm and a struck element. The bracket is electrically connected to a circuit board of the wireless device. The rocker arm is movably disposed on the bracket. The struck element is disposed around the rocker arm, and is electrically connected to the circuit board. When the wireless device is moved and makes the rocker arm move waveringly and touch the struck element, the circuit board is therefore conducted such that the wireless device switches from a sleep mode to an operation mode.

According to a second aspect of the present invention, a wireless device including a casing and a power-saving device is provided. A circuit board and a controlling unit are disposed within the casing. The circuit board is electrically connected to the controlling unit. The controlling unit can activate a sleep mode. The power-saving device disposed within the casing includes a bracket, a rocker arm and a struck element. The bracket is electrically connected to the circuit board. The rocker arm is movably disposed on the bracket. The struck element is disposed around the rocker arm, and is electrically connected to the circuit board. When the casing is moved and makes the rocker arm move waveringly and touch the struck element, the circuit board is conducted and drives the controlling unit to switch from the sleep mode to an operation mode.

The invention will become apparent from the following detailed description of the preferred but non-limiting embodiments. The following description is made with reference to the accompanying drawings.

### BRIEF DESCRIPTION OF THE DRAWINGS

FIG. 1 is a flowchart illustrating the operation of a sleep mode of a wireless mouse;

FIG. 2 is a perspective of a wireless mouse according to a preferred embodiment of the invention; and

FIG. 3 is an exploded diagram of the wireless mouse of FIG. 2.

### DETAILED DESCRIPTION OF THE INVENTION

A wireless device and a power-saving device thereof are provided in the embodiment of the invention. Despite the wireless device has been in sleep mode for long time, the wireless device is still sensitive to a user's operation. In the present embodiment of the invention, the wireless device is exemplified by a wireless mouse.

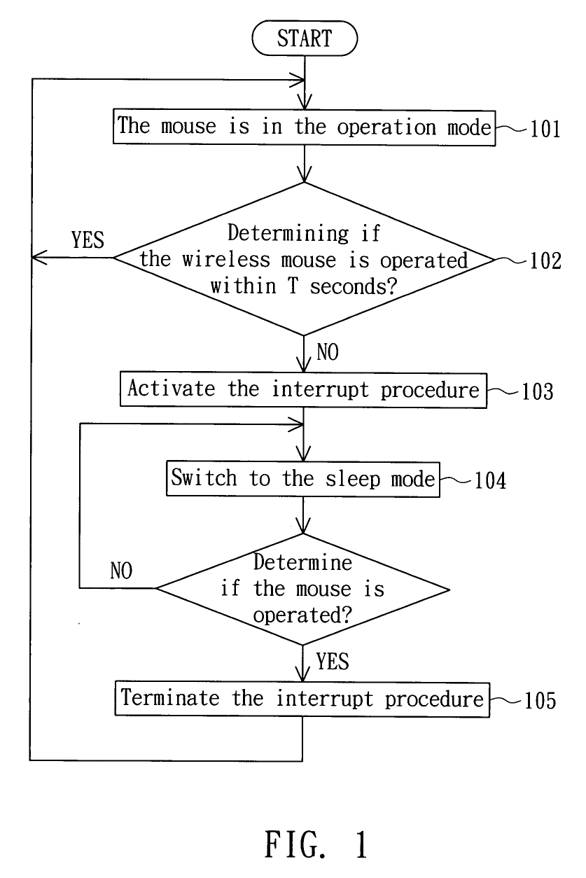

Referring to FIG. 1, a flowchart illustrating the operation of a sleep mode of the wireless mouse is shown. As indicated in FIG. 1, in step 101, when the user continuously operates the wireless mouse, the wireless mouse is always in a normal operation mode. In step 102, whether the wireless mouse is operated within T seconds is determined. If the wireless mouse is in the operation mode but is not operated over T seconds, the process proceeds to step 103. In step 103, the controlling unit of the wireless mouse will activate an interrupt procedure. After the interrupt procedure is activated, the wireless mouse switches to the sleep mode as indicated in step 104. If the user uses the wireless mouse again, the controlling unit will terminate the interrupt procedure as indicated in step 105 and back to the operation mode as indicated in step 101 instead. The duration of time T is determined according to the power-saving method of the wireless mouse. For example, time T is 1 second or 2 seconds.

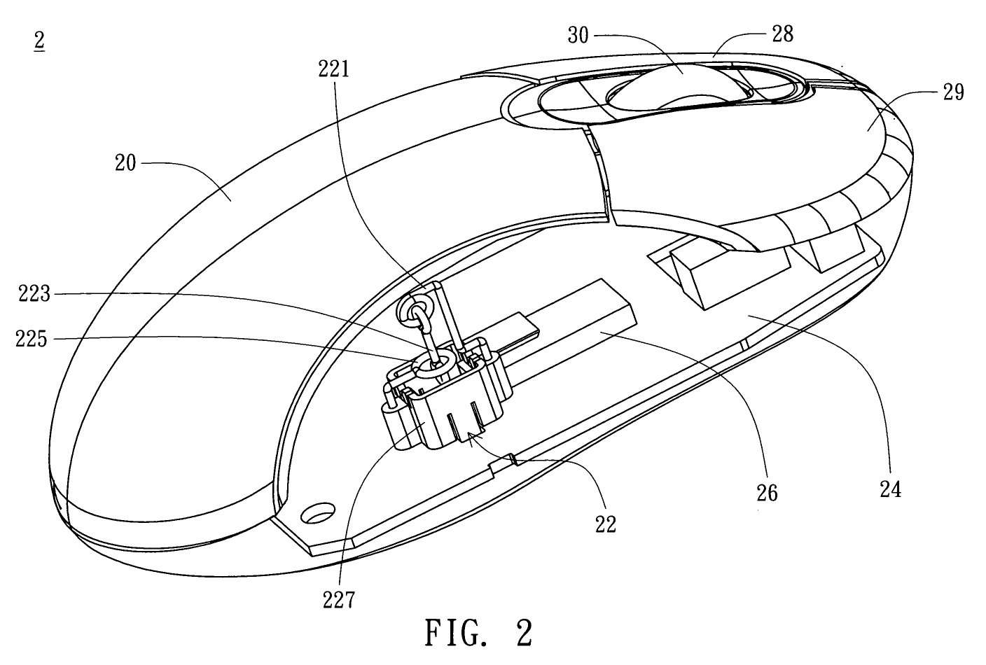

To realize the above power-saving design, the wireless mouse of the embodiment of the invention includes a power-saving device for detecting whether the user operates the wireless mouse under the sleep mode or not. Referring to FIG. 2, a perspective of the wireless mouse according to a preferred embodiment of the invention is shown. As indicated in FIG. 2, the wireless mouse 2 includes a casing 20 and a power-saving device 22. A circuit board 24 and a controlling unit 26 are disposed within the casing 20, wherein the circuit board 24 is electrically connected to the controlling unit 26. The controlling unit 26 is able to activate a sleep mode of the wireless mouse 2.

The wireless mouse 2 further includes two press keys 28 and 29 and a roller 30 both disposed on the casing 20 of the wireless mouse 2 for controlling the movement of the cursor. The location and number of the press keys 28 and 29 and the roller 30 are not restricted and are determined according to the design of the wireless mouse 2.

The power-saving device 22 disposed within the casing 20 includes a bracket 221, a rocker arm 223 and a struck element 225. The bracket 221 is electrically connected to the circuit board 24. The rocker arm 223 is movably disposed on the bracket 221. Preferably, the rocker arm 223 is naturally hung on the bracket 221. The struck element 225 is disposed around the rocker arm 223 and is electrically connected to the circuit board 24. When the casing 20 is moved and makes the rocker arm 223 move waveringly and touch the struck element 225, the circuit board 24 is conducted for driving the controlling unit 26 to terminate the sleep mode and switch to an operation mode.

For convenience, the bracket 221 and the struck element 225 are disposed on a fixed base 227 and then disposed on the circuit board 24. The fixed base 227 is for positioning the bracket 221 and the struck element 225 such that the bracket 221 and the struck element 225 can be combined with the circuit board 24 more steadily. Preferably, the materials of the fixed base 227 include an insulating material such as plastics for example. The materials of the bracket 221, the rocker arm 223 and the struck element 225 include a conductive material such as copper for example.

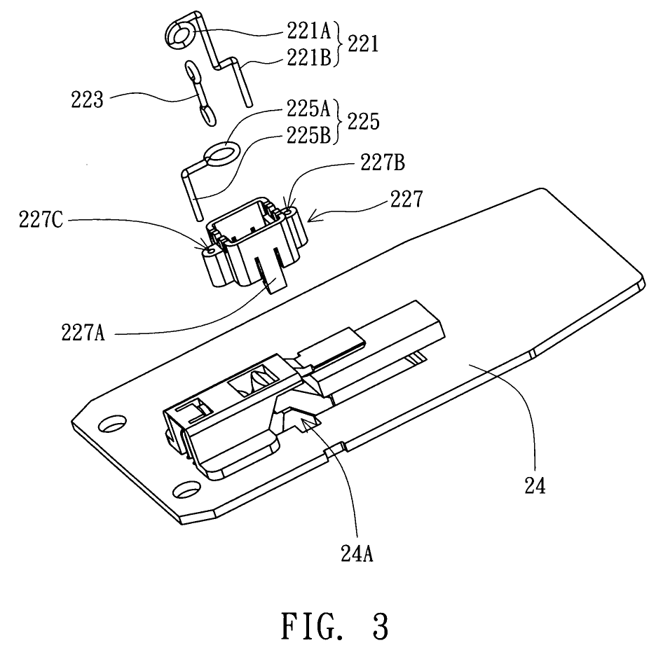

The detailed characteristics of the power-saving device 22 are disclosed in FIG. 3 that an exploded diagram of the wireless mouse of FIG. 2 is shown. As indicated in FIG. 3, the fixed base 227 has at least one positioning hook 227A, one first positioning hole 227B and one second positioning hole 227C. The positioning hook 227A is for coupling with the positioning slot 24A located on the circuit board 24 to fix the fixed base 227 on the circuit board 24. The bracket 221 and the struck element 225 are combined with the fixed base 227 through the first positioning hole 227B and the second positioning hole 227C. The bracket 221 includes a retaining ring 221A and a first pin 221B, wherein the first pin 221B passes through the first positioning hole 227B to electrically connect to the circuit board 24. One end of the rocker arm 223 couples with the retaining ring 221A of the bracket 221, and the struck element 225 surrounds the other end of the rocker arm 223. Preferably, a counter-balance unit is disposed at the other end of the rocker arm 223 such that the rocker arm 223 can be hung in a natural state. When a force is applied to the casing 20 of the wireless mouse 2, the counter-balance unit will enhance the inertia effect of the rocker arm 223. In the embodiment of the invention, the two ends of the rocker arm 223 are circular in shape, wherein one end is connected to the bracket 221 and the other end functions as the counter-balance unit. The struck element 225 includes a ring body 225A and a second pin 225B, wherein the ring body 225A surrounds the rocker arm 223. The second pin 225B of the struck element 225 passes through the second positioning hole 227C of the fixed base 227 to electrically connect to the circuit board 24. The first pin 221B of the bracket 221 and the second pin 225B of the struck element 225 can be electrically connected onto the circuit board 24 by welding.

It is noted that the struck element 225 of the embodiment of the invention surrends the rocker arm 223 via the ring body 225A, such that the rocker arm 223 can touch the struck element 225 regardless of the wavering direction of the rocker arm 223, further increasing the sensibility while detecting the movement of the wireless mouse. In practical use, the shape of the struck element 225 is not restricted as long as the struck element 225 is disposed around the rocker arm 223.

The power-saving device 22 is similar to a switch disposed within the wireless mouse 2. After the interrupt procedure of the wireless mouse 2 is activated as indicated in the step 103 of FIG. 1, when the user moves or shakes the wireless mouse 2 again, the rocker arm 223 will swing like a pendulum due to the inertia effect and touch the struck element 225 nearby. When the rocker arm 223 touches the struck element 225, the bracket 221, the rocker arm 223 and the struck element unit 225 are electrically connected and the circuit board 24 is therefore conducted. Meanwhile, a situation similar to enabling a switch is generated to terminate the interrupt procedure of the wireless mouse 2 as indicated in step 105, and the wireless mouse 2 is switched to the operation mode from the sleep mode as indicated in step 101.

Thus, the operation mode of the wireless mouse 2 will not interfere with the interrupt procedure. Only after the wireless mouse 2 has been lying idle for a period of time (after T seconds) and the interrupt procedure is activated, the wireless mouse 2 will be in the sleep mode.

In practical application, the bracket 221 and the struck element 225 can be connected to the circuit board 24 directly without the fixed base 227. However, even the bracket 221 and the struck element 225 are disposed on the fixed base 227 first, the fixed base 227 is not limited to be disposed on the circuit board 24. The location of the power-saving device 22 is determined according to the arrangement of other components within the wireless mouse 2. The manufacturing and assembly costs will be largely reduced if the bracket 221, the rocker arm 223, the struck element 225 of the power-saving device 22 and the fixed base 227 are combined as a single module.

Conventional wireless mouse still consumes power even in the idle mode, the sleep mode, the deep sleep mode and the operation mode of the conventional wireless mouse is activated only when the press key is pressed. Compared with the conventional wireless mouse, as long as the wireless mouse 2 of the embodiment of the invention is in the idle mode for a period of time (time T as mentioned above), the interrupt procedure will be activated, and the wireless mouse 2 will be in the sleep mode for saving the power. With the use of the power-saving device 22, even in the sleep mode, it is still possible to detect the movement of the wireless mouse 2 and resume the operation mode without omitting the user's operations. The power-saving device is not conducted when the wireless mouse remains in a state of stillness, hence consuming no power. Therefore, the wireless mouse has high power-saving efficiency and the battery lifespan of the wireless mouse is further prolonged.

Despite the wireless device of the embodiment of the invention is exemplified by a wireless mouse, however, the power-saving device of the embodiment of the invention is applicable to a large variety of wireless devices, such as adopting Bluetooth, radio frequency transmission or infrared transmission.

According to the wireless device and the power-saving device thereof disclosed in the above embodiments of the invention, with the design of the rocker arm and the touch-control unit, the power-saving device is still able to detect the movement of the wireless device even when the wireless device is in a sleep mode that is power-saving.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A power-saving device used in a wireless device, wherein the wireless device has a circuit board, the power-saving device comprises:
a bracket electrically connected to the circuit board;
a rocker arm moveably disposed on the bracket; and
a struck element disposed around the rocker arm and electrically connected to the circuit board;
wherein, when the wireless device is moved and makes the rocker arm move waveringly and touch the struck element, the circuit board is therefore conducted such that the wireless device switches from a sleep mode to an operation mode.

2. The power-saving device according to claim 1, wherein one end of the rocker arm is hung on the bracket, the struck element surrounds the other end of the rocker arm.

3. The power-saving device according to claim 2, wherein the bracket comprises a pin and a retaining ring, the pin is electrically connected to the circuit board, the one end of the rocker arm couples with the retaining ring.

4. The power-saving device according to claim 2, wherein the struck element comprises a pin and a ring body, the pin is electrically connected to the circuit board, the other end of the rocker arm is within the ring body.

5. The power-saving device according to claim 2, wherein a counter-balance unit is disposed at the other end of the rocker arm.

6. The power-saving device according to claim 1, further comprising:
a fixed base disposed on the circuit board for carrying the bracket and the struck element, wherein portion of the bracket and portion of the struck element pass through the fixed base to be electrically connected to the circuit board.

7. The power-saving device according to claim 6, wherein the materials of the fixed base include an insulating material.

8. The power-saving device according to claim 1, wherein the materials of the bracket, the rocker arm and the struck element include a conductive material.

9. The power-saving device according to claim 1, wherein the wireless device is a wireless mouse.

10. A wireless device, comprising:
a casing, wherein a circuit board and a controlling unit are electrically connected together and disposed within the casing, the controlling unit is able to activate a sleep mode; and
a power-saving device disposed inside the casing, the power-saving device comprising:
a bracket electrically connected to the circuit board;
a rocker arm moveably disposed on the bracket; and
a struck element disposed around the rocker arm and electrically connected to the circuit board;
wherein, when the casing is moved and makes the rocker arm move waveringly and touch the struck element, the circuit board is therefore conducted and drives the controlling unit to switch from the sleep mode to an operation mode.

11. The wireless device according to claim 10, wherein one end of the rocker arm is hung on the bracket, the struck element surrounds the other end of the rocker arm.

12. The wireless device according to claim 11, wherein the bracket comprises a pin and a retaining ring, the pin is electrically connected to the circuit board, the one end of the rocker arm couples with the retaining ring.

13. The wireless device according to claim 11, wherein the struck element comprises a pin and a ring body, the pin is electrically connected to the circuit board, the other end the rocker arm is within the ring body.

14. The wireless device according to claim 11, wherein a counter-balance unit is disposed at the other end the rocker arm.

15. The wireless device according to claim 10, wherein the power-saving device further comprises a fixed base disposed on the circuit board for carrying the bracket and the struck element, portion of the bracket and portion of the struck element pass through the fixed base to be electrically connected to the circuit board.

16. The wireless device according to claim 15, wherein the materials of the fixed base include an insulating material.

17. The wireless device according to claim 10, wherein the materials of the bracket, the rocker arm and the struck element include a conductive material.

18. The wireless device according to claim 10, wherein the wireless device is a wireless mouse.
